(19) United States
(12) Patent Application Publication
(10) Pub. No.: US 2002/0172548 A1
(43) Pub. Date: Nov. 21, 2002

(54) Locating device fo expandable rod

(76) Inventor: Jung-Hsien Chang, Taichung (TW)

Correspondence Address: LAW OFFICE OF LIAUH & ASSOC., 4224 WAIALAE AVE, STE 5-388, HONOLULU, HI, 96816

(21) Appl. No.: 09/859,756

(22) Filed: May 16, 2001

(51) Int. Cl. B25G 3/00; F16G 11/00

(52) U.S. Cl. 403/305

(57) ABSTRACT

An expandable rod is formed of an outer tube, an inner tube, and a locating device. The locating device comprises a connection tube, a fixation ring, a press member, and rotary tube. The connection tube is fixed on one end of the outer tube by the fixation ring. The press member is disposed in the rotary tube which is rotatable on the connection tube. The inner rod is slidably fitted into one end of the outer tube via the press member. The press member is actuated by the rotary tube to catch or release the rod body of the inner tube.

### FIELD OF THE INVENTION

The present invention relates generally to an expandable rod, and more particularly to a locating device of the expandable rod.

### BACKGROUND OF THE INVENTION

As shown in FIG. 1, a prior art expandable rod comprises an outer tube 01, an inner tube O2, and an elastic piece 03. The inner tube 02 is slidably fitted into the outer tube 01 in conjunction with the elastic piece 03. The outer tube 01 is provided with a retaining hole 011. The elastic piece 03 is provided with a retaining projection 031, which is retained in the retaining hole 011 of the outer tube 01 for locating the inner tube O2 and the outer tube 01. The locating effect of the elastic piece 03 is poor.

As shown in FIG. 2, another prior art expandable rod comprises an outer tube 01, an inner tube 02 slidably fitted into the outer tube 01, and a locating piece 04. The outer tube 01 is provided in one side of the front end with a cut 012 in which the locating piece 04 is disposed for locating the inner tube O2 in conjunction with a wrenching piece 05 by means of which the locating piece 04 is forced to locate the inner tube 02. The wrenching piece 05 is apt to be impacted on by the external force to upset the locating effect of the locating piece 04. In addition, the wrenching piece 05 undermines the esthetic effect of the expandable rod. The outer tube O1 must be provided with the cut 012 to accommodate the locating piece 04 and is therefore not cost-effective.

### SUMMARY OF THE INVENTION

The primary objective of the present invention is to provide an expandable rod with a locating device which is free of the deficiencies of the prior art locating devices described above.

In keeping with the principle of the present invention, the foregoing objective of the present invention is attained by a locating device which is formed of a connection tube, a fixation ring, a press member, and a rotary tube. The locating device is disposed at one end of an outer tube into which an inner tube is slidably fitted. The connection tube is fixed at one end of the outer tube by the fixation ring. The rotary tube is provided with is a tapered hole into which the press member is inserted. The inner tube is slidably fitted into the outer tube via one end of the rotary tube. The inner tube is extracted from or retracted into the outer tube by rotating the rotary tube.

The features and functions of the present invention will be more readily understood upon a thoughtful deliberation of the following detailed description of a preferred embodiment of the present invention in reference to the accompanying drawings.

### BRIEF DESCRIPTION OF THE DRAWINGS

FIG. 1 shows an exploded view of a prior art expandable rod.

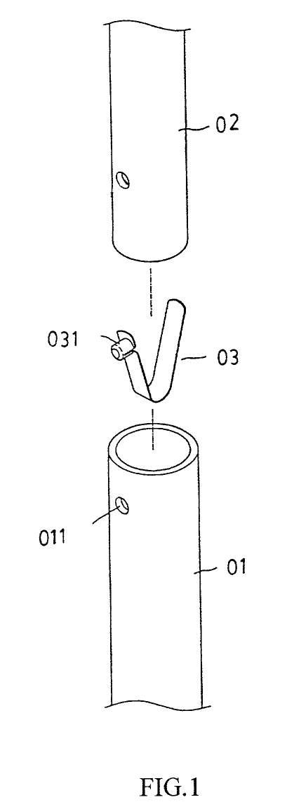

FIG. 2 shows a longitudinal sectional view of another prior art expandable rod.

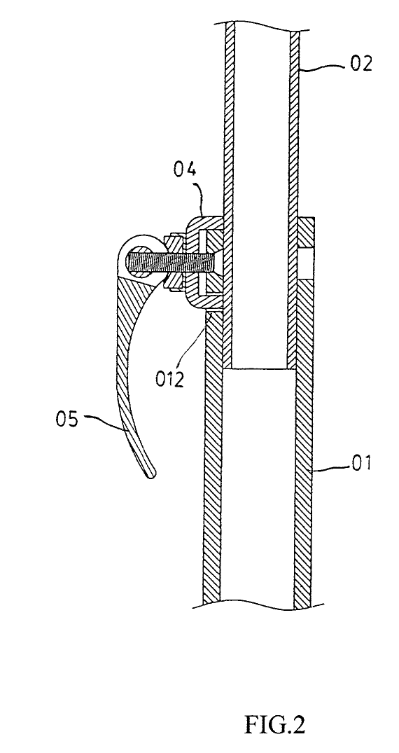

FIG. 3 shows an exploded view of the preferred embodiment of the present invention.

FIG. 4 shows a sectional view of the rotary tube of the preferred embodiment of the present invention.

FIG. 5 shows a perspective view of the preferred embodiment of the present invention in combination.

FIG. 6 shows a longitudinal sectional view of the preferred embodiment of the present invention in combination.

FIG. 7 shows a schematic view of the preferred embodiment of the present invention at work.

### DETAILED DESCRIPTION OF THE PREFERRED EMBODIMENTS

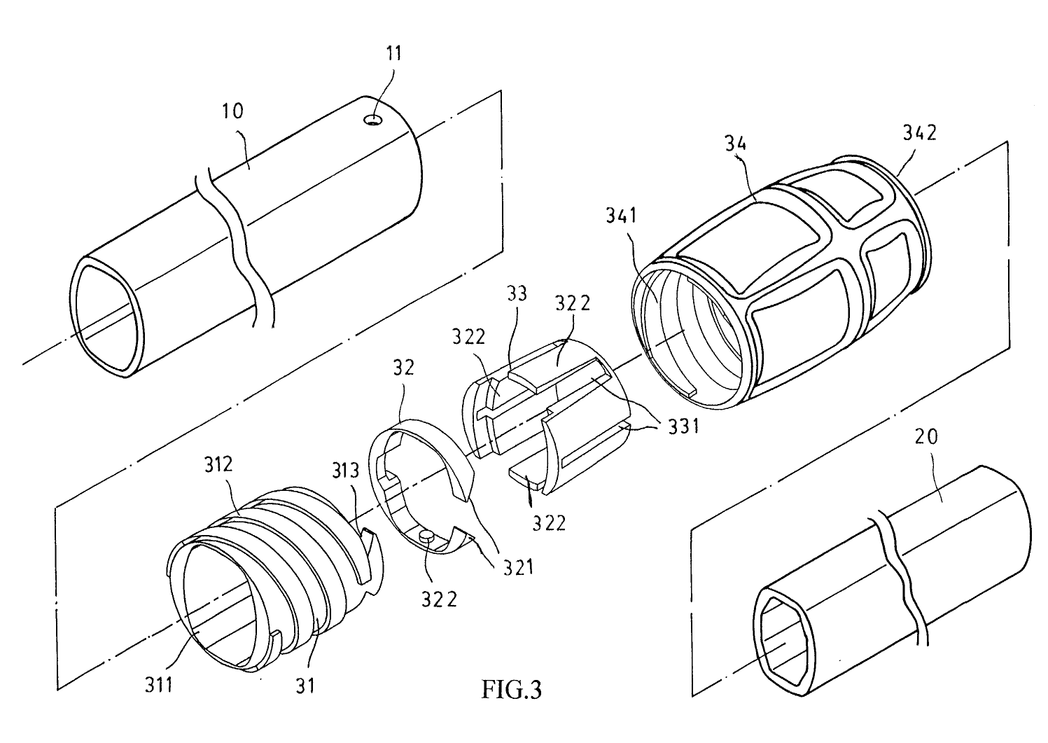

As shows is FIG. 3, an expandable rod embodied in the present invention is formed of an outer tube 10, an inner tube 20, and a locating device 30.

The outer tube 10 is hollow and provided in two sides of one end thereof with a fixation hole 11.

The inner tube 20 is hollow and slidably fitted into the outer tube 10.

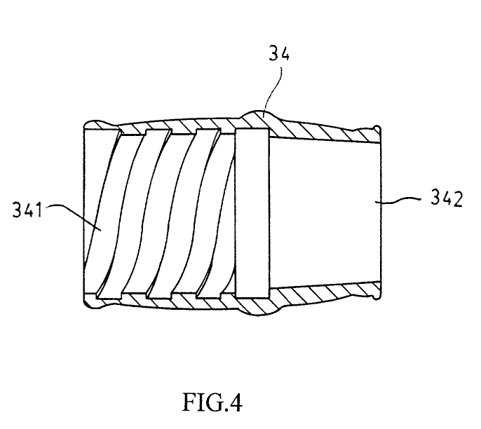

The locating device 30 is disposed at the junction of the outer tube 10 and the inner tube 20 such that the locating device 30 enables the inner tube 20 to be extracted from or retracted into the outer tube 10, and that the locating device 30 serves to locate the inner tube 20. The locating device 30 comprises a connection tube 31, a fixation ring 32, a press member 33, and a rotary tube 34. The connection tube 31 is provided with a connection hole 311 extending along the longitudinal direction of the connection tube 31 and corresponding in the cross-sectional shape to the outer tube 10. The connection tube 31 is provided in the outer wall with a plurality of outer threads 312, and at one end thereof with a retaining slot 313. The fixation ring 32 is a C-shaped elastic ring and is provided with a retaining end 321 which is retained in the retaining slot 313. The fixation ring 32 is further provided with two fixation projections 322 corresponding in location to the fixation holes 11 of the outer tube 10. The press member 33 is of a hollow and tapered construction and is corresponding in the cross-sectional shape to the inner tube 20. The side wall of the press member 33 is formed of a plurality of elastic press pieces 332 and through slots 331 alternate with the press pieces 332. The rotary tube 34 is provided at one end with a plurality of inner threads 341 engageable with the outer threads 312 of the connection tube 31. The rotary tube 34 is further provided at other end with a tapered hole 342, as shown in FIG. 4. The tapered hole 342 of the rotary tube 34 is corresponding in the tapering form to the press member 33.

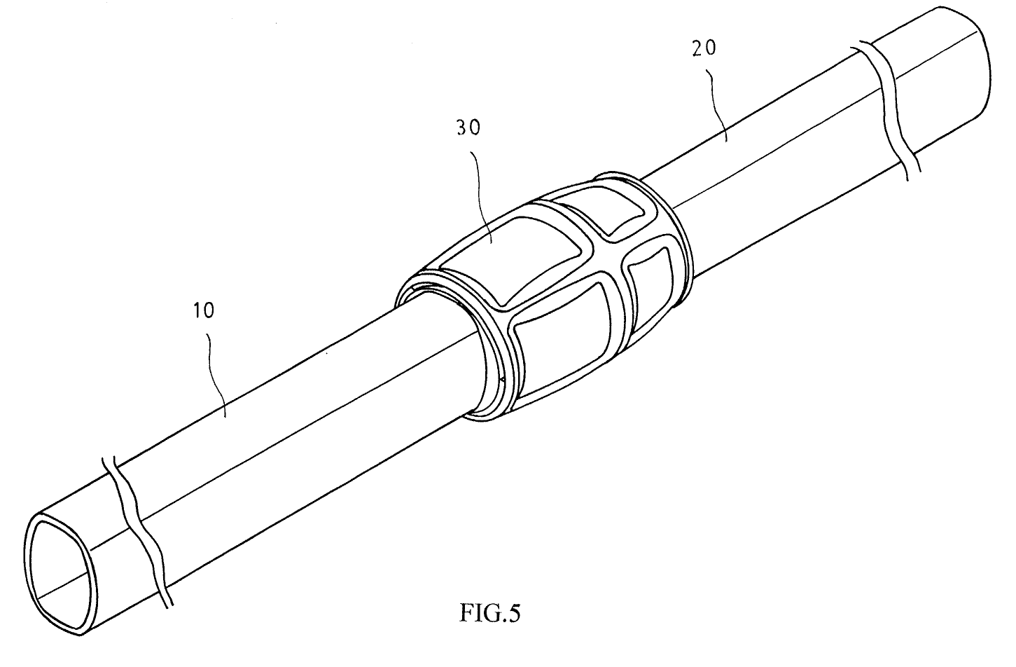

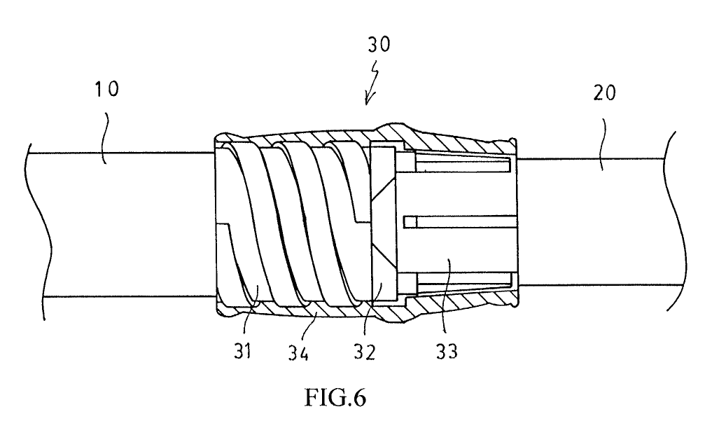

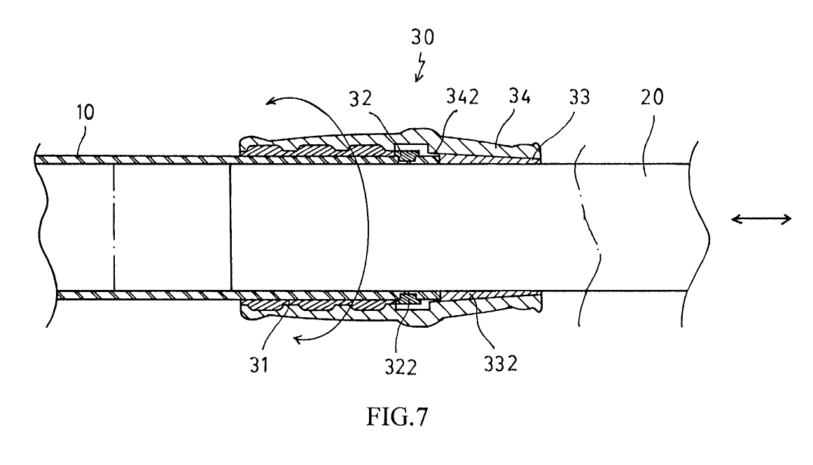

As illustrated in FIGS. 5 and 6 in conjunction with FIG. 7, the locating device 30 is disposed between the outer tube 10 and the inner tube 20 such that one end of the outer tube 10 is fitted into the connection tube 31, with the fixation holes 11 of the outer tube 10 being located in the retaining slot 313 of the connection tube 31. The outer tube 31 is fixed by the fixation ring 32 which is inserted into the retaining slot 313 such that the fixation projections 322 of the fixation ring 32 are inserted into the fixation holes 11 of the outer tube 10. As the connection tube 31 is fixed on the outer tube 10, the press member 33 is inserted into the tapered hole 342 of the rotary tube 34 before the inner threads 341 of the rotary tube 34 are engaged with the outer threads 312 of the connection tube 31. The rotary tube 34 can be turned on the connection tube 31. The inner tube 20 is slidably fitted into the hollow outer tube 10 via the press member 33 which is located in the rotary tube 34. When the inner tube 20 is slid out of the outer tube 10 to an extent that the expandable rod of the present invention has a desired length, the rotary tube 34 is turned forward such that the tapered hloe 342 forces the press pieces 332 of the press member 33 to hold the rod body of the inner tube 20. The inner tube 20 is thus located. If the inner tube 20 is to be further adjusted in length, the rotary tube 34 is rotated in reverse to allow the tapered hole 342 to release the press pieces 332 of the press member 33. As a result, the rod body of the inner tube 20 is no longer held by the press pieces 332 of the press member 33, thereby enabling the inner tube 20 to be slid once again so as to adjust the length of the expandable rod.

The embodiment of the present invention described above is to be regarded in all respects as being merely illustrative and not restrictive. Accordingly, the present invention may be embodied in other specific forms without deviating from the spirit thereof. The present invention is therefore to be limited only by the scopes of the following claims.

What is claimed is:

1. An expandable rod comprising:
a hollow outer tube provided at one end with two fixation holes opposite in location to each other;
an inner tube slidably fitted into said outer tube; and
a locating device disposed at a junction of said outer tube and said inner tube for controlling the sliding of said inner tube and for locating said inner tube;
wherein said locating device comprises:
a connection tube provided with a connection hole extending along the longitudinal direction of said connection tube, said connection tube further provided in an outer wall with a plurality of outer threads, and at one end with a retaining slot;
a fixation ring provided with a retaining end which is retained in said retaining slot of said connection tube, said fixation ring further provided with two fixation projections corresponding in location to said fixation holes of said outer tube;
a press member of a hollow and tapered construction and having a plurality of elastic press pieces; and
a rotary tube provided at one end with a plurality of inner threads engageable with said outer threads of said connection tube, said rotary tube further provided at other end with a tapered hole;
said locating device being disposed at the junction of said outer tube and said inner tube such that one end of said outer tube is fitted into said connection tube, and that said fixation holes of said one end of said outer tube are located in said retaining slot of said connection tube, and further that said fixation ring is disposed in said retaining slot of said connection tube to enable said fixation projections of said fixation ring to be retained in said fixation holes of said outer tube, and further that said press member is inserted into said tapered hole of said rotary tube, and further that said inner threads of said rotary tube are engaged with said outer threads of said connection tube whereby said press pieces of said press member are actuated by said tapered hole to catch or release said inner tube which is slidably fitted into said outer tube via said press member.

2. The expandable rod as defined in claim 1, wherein said connection hole of said connection tube is corresponding in cross-sectional shape to said outer tube; wherein said hollow press member has a hollow interior corresponding in cross-sectional shape to said inner tube.
